(19) United States
(12) Patent Application Publication
(10) Pub. No.: US 2004/0000509 A1
(43) Pub. Date: Jan. 1, 2004

(54) Screw pressing type filtering apparatus

(75) Inventors: Takashi Murasawa, Tokyo (JP); Yoshiyuki Moro, Tokyo (JP); Tetsuhiro Nishikawa, Tokyo (JP)

Correspondence Address: Koda & Androlia, Suite 3850, 2029 Century Park East, Los Angeles, CA, 90067, US

(73) Assignee: Tsukishima Kikai Co., Ltd.

(21) Appl. No.: 10/185,581

(22) Filed: Jun. 28, 2002

(51) Int. Cl. B01D 35/14

(52) U.S. Cl. 210/90; 210/91; 210/109; 210/143; 210/224

(57) ABSTRACT

A screw pressing type filtering apparatus that discharges a treated substance having a constant water content, including a screw rotatably provided inside a substantially cylindrical filter body so that a substance supplied to the space between the screw and the filter body is filtered by the filter body while being conveyed by the rotating screw. The apparatus further includes: a back pressure valve installed in the discharge port of the filter body to restrict the discharge amount of the filtered substance, an air cylinder that supplies a pressure to the back pressure valve, a valve opening detector which detects the opening amount of the back pressure valve relative to the discharge port, and a control section which controls the air cylinder based upon the detection results of the valve opening detector so that a pressure that corresponds to the degree of opening is supplied to the back pressure valve.

### BACKGROUND OF THE INVENTION

1. Field of the Invention

The present invention relates to a screw pressing type filtering apparatus which discharges cakes having constant water content even in cases where the supply amount of the substance to be treated fluctuates.

2. Prior Art

Screw pressing type filtering apparatuses have been used conventionally. In such a filtering apparatus, a substance that is to be treated and has a high water content such as sludge, etc. is supplied to a cylindrical filter body via a supply port, and this substance is filtered by the filter body while being conveyed to a discharge port by a screw that is provided inside the cylindrical filter body.

The screw pressing type filtering apparatus as described above includes a back pressure valve. The back pressure valve is installed in the discharge port and restricts the discharge of the substance treated from the discharge port. The back pressure valve is caused to make a reciprocating motion in the axial direction of the screw by a driving means so that the pressure that restricts the discharge of the substance is kept constant. As a result, the water content of the substance treated and discharged from the discharge port is controlled to a constant value.

However, in the case of the screw pressing type filtering apparatus of the above-described prior art, when the supply amount of the substance to be treated is increased, the pressure by which the substance that has been treated is pushed out through the discharge port increases; but since the pressure of the back pressure valve is constant, the back pressure caused by the substance exceeds the pressure of the back pressure valve. As a result, the opening rate of the discharge port increases, and filtration is accelerated, thus causing the water content of the substance treated to decrease.

On the other hand, in the screw pressing type filtering apparatus of the prior art, when the supply amount of the substance to be treated is decreased, the pressure by which the substance that has been treated is pushed out through the discharge port decreases as the supply amount of the substance to be treated decreases; but since the pressure of the back pressure valve is constant, the back pressure decreases below the pressure of the back pressure valve. As a result, the opening rate of he discharge port decreases. However, since the substance is discharged before a sufficient filtration has been performed, the substance treated has high water content.

As seen from the above, in the prior art screw pressing type filtering apparatus, the water content of the substance that has been treated and is discharged from the discharge port fluctuates as a result of the changes in the supply amount of the substance to be treated.

Furthermore, since the water content of the substance that has been treated and discharged from the discharge port fluctuates, irregularities generate in the products that are manufactured using the discharged substance. Furthermore, in cases where the discharged substance is incinerated, it is necessary to control the supply amount of burning fuel in accordance with the water content of the discharged substance in order to secure a constant burning of the substance. Thus, after-stage treatment becomes complicated.

### SUMMARY OF THE INVENTION

The present invention was devised in light of the facts described above; and the object of the present invention is to provide a screw pressing type filtering apparatus that discharges filtered substance having a constant water content value even in cases where the amount of filtering treatment fluctuates.

In order to accomplish the above-described object, the present invention provides a screw pressing type filtering apparatus that comprises a substantially cylindrical filter body and a screw rotatably installed in the filter body so that a substance supplied from one end of the screw into a space between the screw and the filter body is filtered by the filter body while being conveyed to another end of the screw by rotation of the screw; and in the present invention, the filtering apparatus is characterized in that it comprises:

a back pressure valve installed in a discharge port at another end of the filter body so as to restrict a discharge of the substance which has been filtered;

a pressurizing means which supplies a pressure, which restricts the discharge of the substance that has been filtered, to the back pressure valve;

an opening detection means which detects a degree of opening between the discharge port and the back pressure valve; and

a control means which controls the pressurizing means based upon the detection results of the opening detection means so that a pressure that corresponds to the degree of opening is supplied to the back pressure valve.

Furthermore, the present invention is characterized in that in the above-described screw pressing type filtering apparatus, the control means controls the pressurizing means based upon the detection results of the opening detection means so that a pressure that is supplied to the back pressure valve is lowered in cases where the degree of opening of the back pressure valve exceeds a predetermined degree of opening and so that the pressure that is supplied to the back pressure valve is raised in cases where the degree of opening of the back pressure valve is less than the predetermined degree of opening.

The present invention is further characterized in that:

the pressurizing means has a pressure detection means that detects a pressure supplied to the back pressure valve, and

the control means controls the pressure of the back pressure valve so that a product of detection results of the opening detection means and detection results of the pressure detection means becomes a specified value.

In addition, the present invention is characterized in that the pressurizing means is an air cylinder.

Furthermore, the present invention provides a filtration method for a screw pressing type filtering apparatus that comprises a substantially cylindrical filter body and a screw rotatably disposed in the filter body so that a substance supplied from one end of the screw into a space between the screw and the filter body is filtered by the filter body while being conveyed to another end of the screw by rotation of the screw; and the method of the present invention is characterized in that it comprises the steps of:

restricting the discharge of a filtered substance, which has been treated, by a back pressure valve installed in a discharge port that is at another end of the filter body;

detecting a degree of opening between the discharge port and the back pressure valve; and

supplying a pressure that corresponds to the degree of opening to the back pressure valve based upon detection results of the degree of opening.

In addition, the present invention provides a recording medium which is recorded with a control program and is used in a screw pressing type filtering apparatus that comprises a substantially cylindrical filter body and a screw rotatably disposed in the filter body so that a substance supplied from one end of the screw into a space between the screw and the filter body is filtered by the filter body while being conveyed to another end of the screw by rotation of the screw; and the recording medium of the present invention is characterized in that it causes a computer to execute:

a step of restricting the discharge of a filtered substance, which has been treated, by a back pressure valve installed in a discharge port that is at another end of the filter body;

a step of detecting a degree of opening between the discharge port and the back pressure valve; and

a step of supplying a pressure that corresponds to the degree of opening to the back pressure valve based upon detection results of the degree of opening.

### BRIEF DESCRIPTION OF THE DRAWINGS

FIG. 1 is a schematic block diagram showing the structure of the screw pressing type filtering apparatus according to one embodiment of the present invention;

FIG. 2 is a graph that shows the relationship of the water content of the cake to the product of the degree of opening and the back pressure; and

FIG. 3 is a flow chart representing the operation of the screw pressing type filtering apparatus.

### DETAILED DESCRIPTION OF THE INVENTION

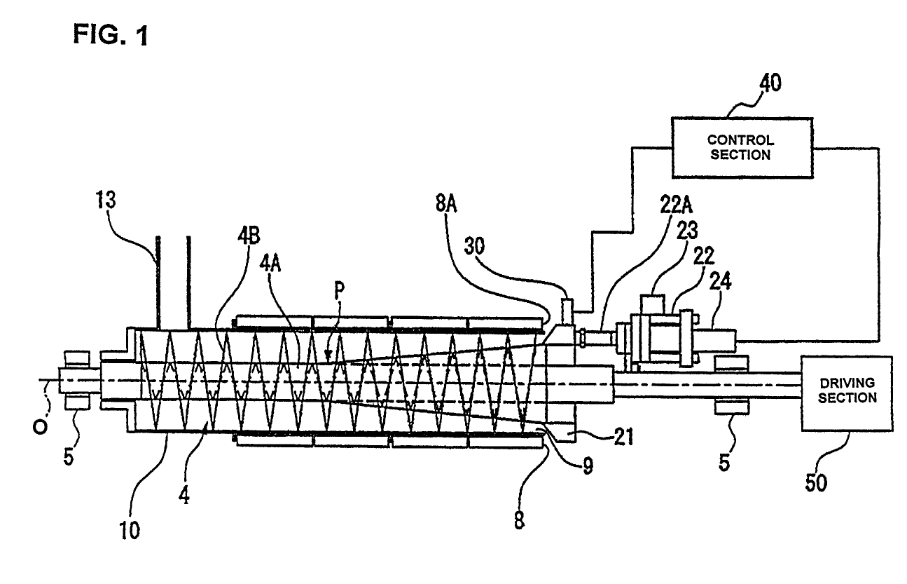

Below, a screw pressing type filtering apparatus according to one embodiment of the present invention will be described with reference to the accompanying drawings. FIG. 1 is a schematic structural diagram that shows the structure of the screw pressing type filtering apparatus constructed according to one embodiment of the present invention. In this FIG. 1, a screw 4 has screw vanes 4B which are formed in a helical configuration on the outer circumference of a screw shaft 4A with an axial line O as the center, and this screw 4 is supported by bearings 5, 5 so that the screw 4 is free to rotate. A driving section 50 that causes the screw 4 to rotate is disposed at the end of the screw shaft 4A supported by the bearing 5 which is at another end of the screw 4.

The driving section 50 is connected to the screw shaft 4A, and thus the screw 4 is rotatable about the axial line O and conveys a substance to be treated that is supplied from one end to another end of the screw. The driving section 50 is, for instance, a motor.

The screw angle and the external diameter of the screw vanes 4B of the screw 4 are consistent from one end to another end of the screw 4. Meanwhile, in the portion where the screw vane 4B is formed, the outer circumference of the screw shaft 4A is set so as to have a constant external diameter in the area that extends from one end to the position P and is set so as to have a gradually enlarging diameter from the position P toward another end of the screw 4. As a result, the spaces between the outer circumference of the screw shaft 4A and the screw vanes 4B that are adjacent to each other in the direction of the axial line O are smaller from one end toward another end of the screw 4. Instead of varying the external diameter of the screw shaft 4A so that the diameter increases toward another end of the screw 4 as described above, it is also possible to reduce the size of the above-described spaces by way of setting the external diameter of the screw shaft 4A to be consistent and reducing the pitch of the screw vanes 4B toward another end of the screw 4. Alternatively, it is further possible to reduce the size of the above-described spaces at another end of the screw 4 by way of using a combination of the above-described two configurations, thus increasing the external diameter of the screw shaft 4A and reducing the pitch of the screw vanes 4B at another end of the screw 4.

The filter body 10 has a substantially cylindrical shape, and the screw 4 is provided inside this filter body 10. As a result, the substance that is being treated is dehydrated and filtered by the filter body 10 while being conveyed by the screw 4 from one end to another end of the screw. Furthermore, a tubular supply section 13 which supplies the substance to be treated is provided at one end of the filter body 10.

The discharge port 9 at another end of the filter body 10 discharges the filtered substance, which has been treated, as a cake.

A back pressure valve 21 is provided at the discharge port 9, and it restricts the discharge of the cake. The back pressure valve 21 is formed in an annular shape that fits on the discharge port 9 in such a manner that the valve 21 can advance and retract in the direction of the axial line O. The screw 4 is provided so as to pass through this back pressure valve 21. The back pressure valve 21 has an external diameter that is larger than the internal diameter of the discharge port 9 formed, in order to discharge the cake, in the end portion 8 which is at another end of the filter body 10. Moreover, the back pressure valve 21 has a tapered surface. The tapered surface is formed so as to have a gradually enlarged diameter toward another end of the screw 4.

Furthermore, the piston rod 22A of an air cylinder 22 that is provided near the end portion 8 of the filter body 10 is connected to the back pressure valve 21. The piston rod 22A sets the spacing between the back pressure valve 21 and the end portion 8A at an appropriate value by making a protruding and retraction action parallel to the axial line O with respect to one end of the air cylinder 22. As a result, the back pressure valve 21 is caused to advance or retract, thus making it possible to adjust the amount of cake that is discharged from the discharge port 9. Here, the pressure that is applied to the substance that is being treated inside the filter body 10 by the back pressure valve 21 is called the “pressure of the back pressure valve”, and the pressure that is received by the substance that is being treated inside the filter body 10 is called the “back pressure”.

Via the piston rod 22A, the air cylinder 22 generates a pressure in the back pressure valve 21 (pressure of the back pressure valve) that restricts the discharge of the substance treated. The air cylinder 22 is, in the present invention, the pressurizing means; and the control of the pressure of the back pressure valve is easily controlled by this air cylinder 22.

A valve opening detector 30 detects the distance between the back pressure valve 21 and the end portion 8A of the filter body 10. Based upon this detection result, the valve opening detector 30 further detects the degree of opening between the discharge port 9 and the back pressure valve 21. Then, the valve opening detector 30 outputs a detection result to the control section 40 as the degree of opening I of the back pressure valve 21.

An air cylinder controller 24 controls, based upon a control signal from the control section 40, the pressure generated by the air cylinder 22.

The pressure detector 23 detects the pressure of the back pressure valve that is generated by the back pressure valve 21 and outputs the detection result to the control section 40 as a back pressure detection value p. More specifically, with an assumption that the pressure applied to the substance being treated inside the filter body 10 by the back pressure valve 21 and the pressure received by the substance being treated inside the filter body 10 are substantially the same, the pressure of the back pressure valve generated by the back pressure valve 21 is outputted to the control section 40 as the back pressure detection value p.

Next, an explanation of the control section 40 will be made. The control section 40 outputs a control signal to the air cylinder controller 24 based upon the detection result of the valve opening detector 30 so that a pressure that corresponds to the degree of opening is supplied to the back pressure valve 21 from the air cylinder 22.

Furthermore, the control section 40 performs a control action that increases or decreases the pressure of the back pressure valve 21 so that the product of the degree of opening I of the valve 21 and the back pressure detection value p becomes equal to a dehydrated sludge water content coefficient k. Here, the degree of opening I is the detection result of the valve opening detector 30, and the back pressure detection value p is the detection result of the pressure detector 23. The dehydrated sludge water content coefficient k is set based upon a specified water content. Moreover, when the degree of opening I of the valve is zero, then the control section 40 outputs a control signal to the air cylinder controller 24 so that a predetermined pressure of the back pressure valve is obtained.

Here, the dehydrated sludge water content coefficient k is set based upon the type of substance that is to be treated, the desired water content, etc.

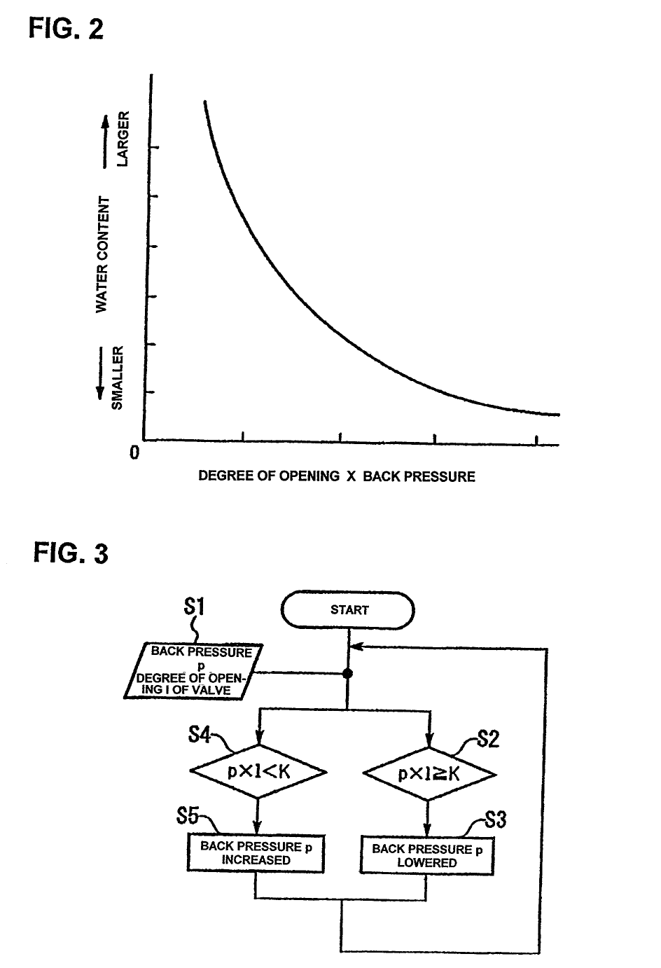

Next, the relationship of the water content of the cake to the product of the degree of opening and back pressure will be described with reference to FIG. 2.

FIG. 2 is a graph that shows the relationship of the water content of the cake to the product of the degree of opening and the back pressure. As seen from FIG. 2, the water content of the cake is inversely proportional to the product of the degree of opening and the back pressure. For example, in cases where the back pressure is fixed and the degree of opening is increased, the water content of the cake that is discharged from the discharge port 9 drops. On the other hand, in cases where the back pressure is likewise fixed and the degree of opening is decreased, then the water content of the cake rises.

Meanwhile, in cases where the degree of opening is fixed and the back pressure is increased, the water content of the cake drops; and in cases where the degree of opening is fixed and the back pressure is lowered, then the water content of the cake rises.

Furthermore, it has been determined by experiments that the relationship of the water content of the cake to the product of the degree of opening and the back pressure shown in FIG. 2 does not depend on the amount of treatment of the substance.

Next, the operation of the screw pressing type filtering apparatus having thee structure of FIG. 1 will be described with reference to FIGS. 1 and 3. FIG. 3 is a flow chart that illustrates the operation of the screw pressing type filtering apparatus.

Prior to the initiation of the dehydration process in which the screw pressing type filtering apparatus dehydrates the substance being treated, the back pressure valve 21 is in contact with the end portion 8 of the filter body 10 with a predetermined pressure of the back pressure valve based upon the desired water content of the treated substance.

First, the rotation of the driving section 50 is transmitted to the screw shaft 4A, and the substance to be treated is successively supplied from the supply section 13.

Then, the substance supplied from the supply section 13 flows into the space formed by the filter body 10, screw vanes 4B and screw shaft 4A and is gradually filtered and dehydrated as a result of the reduction in the volume of the above-described space while being conveyed from one end of the filter body 10 to another end thereof by the rotation of the screw 4.

Next, the substance being treated reaches the end portion 8 of the filter body 10. Since the discharge port 9 is not open at this point in time, the substance that reaches the end portion 8 accumulates in the vicinity of the discharge port 9. The back pressure in the vicinity of the discharge port 9 gradually increases as the substance to be treated is further supplied from the supply section 13 and further filtration is performed to the substance. When the pressure that pushes the substance treated toward another end of the filter body 10 increases and the back pressure exceeds the pressure of the back pressure valve 21, the back pressure valve 21 is pushed and separated from the filter body 10. As a result, the filtered substance is discharged as a cake that has a desired water content from the discharge port 9 between the filter body 10 and the back pressure valve 21.

After the cake has been discharged, the degree of opening of the back pressure valve 21 is detected by the valve opening detector 30; and the detection result is outputted to the control section 40 as the degree of opening I of the valve. Furthermore, the pressure of the back pressure valve 21 that is detected by the pressure detector 23 is outputted to the control section 40 as the back pressure detection value p (step S 1). The control section 40 calculates the product of the degree of opening I of the valve outputted from the valve opening detector 30 and the back pressure detection value p outputted from the pressure detector 23, and then it compares the result of this calculation with the dehydrated sludge water content coefficient k.

In cases where the product of the degree of opening I of the valve and back pressure p is greater than the dehydrated sludge water content coefficient k in the results of this comparison (step S2), the control section 40 outputs to the air cylinder controller 24 a control signal. This control signal is to reduce the pressure of the back pressure valve 21 so that the back pressure corresponds to the current degree of opening I of the valve, i.e., so that the back pressure is equal to the back pressure calculated on the basis of the dehydrated sludge water content coefficient k and the degree of opening I of the valve (step S3). Based upon the control signal outputted from the control section 40, the air cylinder controller 24 controls the air cylinder 22 so that the pressure of the back pressure valve is reduced.

Thus, even if the degree of opening of the back pressure valve 21 is increased due to the supply of the substance to be treated, a control is made so that the pressure of the back pressure valve drops for obtaining a fixed water content. As a result, the water content of the cake that is discharged can be maintained at a constant value.

Here, when the amount of the substance to be treated and supplied from the supply section 13 is constant, the back pressure valve 21 is maintained at a position of the degree of opening I of the valve that occurs when the ratio of the amount of the substance supplied and the amount of cake that is discharged are constant.

Next, when the amount of the substance to be treated and supplied from the supply section 13 increases, the amount of the substance being treated and conveyed by the screw 4 increases, so that the pressure with which the substance is pushed to the discharge port 9 increases. When the pressure that pushes the substance being treated to the discharge port 9 thus increases, the back pressure of the substance inside the filter body 10 increases. When the back pressure exceeds the pressure of the back pressure valve 21, the back pressure valve 21 is pushed by the back pressure in the direction that causes this back pressure valve 21 to be separated from the discharge port 9, increasing the degree of opening I of the valve.

In this case, the control section 40 reads out the degree of opening I of the valve 21 that is outputted from the valve opening detector 30 and the back pressure detection value p that is outputted from the pressure detector 23 (step S1). The control section 40 calculates the product of this read-out degree of opening I of the valve and the back pressure detection value p and compares the result of this calculation with the dehydrated sludge water content coefficient k. Since the degree of opening I of the valve has become larger, it is detected that the calculated result is greater than the dehydrated sludge water content coefficient k (step S2).

When it is detected that the calculated result is greater than the dehydrated sludge water content coefficient k, the control section 40 outputs to the air cylinder controller 24 a signal that reduces the pressure of the back pressure valve 21 so that a back pressure that corresponds to the current degree of opening I of the valve 21 is obtained, i.e., so that the back pressure is equal to the back pressure calculated on the basis of the dehydrated sludge water content coefficient k and the degree of opening I of the valve (step S3).

Thus, even if the degree of opening of the back pressure valve 21 is increased in response to the increase in the supply amount of the substance to be treated, a control action is performed so that the pressure of the back pressure valve is lowered, thus ensuring that the water content of the treated substance is constant. As a result, the water content of the cake that is discharged is maintained at a constant value.

Next, when the amount of the substance to be treated and supplied form the supply section 13 decreases, the amount of the substance being treated and conveyed by the screw 4 decreases, so that the pressure with which the substance treated is pushed to the discharge port 9 decreases. When the pressure that pushes the substance being treated to the discharge port 9 thus decreases, the back pressure of the substance inside the filter body 10 decreases. When hen the back pressure decreases below the pressure of the back pressure valve 21, the back pressure valve 21 receives the pressure from the piston rod 22A, and the back pressure valve 21 is pushed back toward the discharge port 9, decreasing the degree of opening I of the valve 21.

In this case, the control section 40 reads out the degree of opening I of the valve 21 that is outputted from the valve opening detector 30 and the back pressure detection value p that is outputted from the pressure detector 23 (step S1). The control section 40 calculates the product of this read-out degree of opening I of the valve and the back pressure detection value p and compares the result of this calculation with the dehydrated sludge water content coefficient k. Since the back pressure valve 21 has been pushed back toward the discharge port 9, the degree of opening I of the valve has become smaller. As a result, it is detected that the calculated result is smaller than the dehydrated sludge water content coefficient k (step S2).

When it is detected that the calculated result is smaller than the dehydrated sludge water content coefficient k, the control section 40 outputs to the air cylinder controller 24 a control signal that increases the pressure of the back pressure valve so that a back pressure that corresponds to the current degree of opening I of the valve is obtained, i.e., so that the back pressure is equal to the back pressure calculated on the basis of the dehydrated sludge water content coefficient k and the degree of opening I of the valve (step S3).

Thus, even if the degree of opening of the back pressure valve 21 is reduced in response to the reduction in the supply amount of the substance to be treated, a control action is performed so that the pressure of the back pressure valve is increased, thus ensuring that the water content of the treated substance is constant. As a result, the water content of the cake that is discharged is maintained at a constant value.

In the above-described embodiment, as described above, the water content of the cake can be maintained at a constant value. Accordingly, in cases where a product is manufactured using the discharged treated substance, the occurrence of irregularities in the product can be prevented. Furthermore, in cases where the discharged treated product is incinerated, since the water content of the treated product is maintained at a constant value, control of the amount of fuel supplied in the incineration can be accomplished simply, and thus after-stage treatments can be simplified.

The above embodiment is described with reference to the case in which an air cylinder is used as the pressurizing means. However, it is also possible to supply a pressure to the back pressure valve 21 using a means other than an air cylinder.

Furthermore, in the above-described embodiment, the control section 40 performs a control action so that the pressure of the back pressure valve 21 is increased or decreased in order to cause the product of the degree of opening I of the valve and the back pressure detection value p to become equal to the dehydrated sludge water content coefficient k. However, it can be designed differently. In other words, a set degree of opening a, which is a degree of opening that is set in accordance with the type of substance to be treated and the desired water content, is first stored in the control section 40 beforehand. Then, the control section 40 compares the degree of opening I of the valve with the predetermined degree of opening a stored beforehand in the control section 40. As a result, the control section 40 outputs control signals to the air cylinder controller 24 of the air cylinder 22 so that the pressure that is supplied to the back pressure valve 21 decreases when the degree of opening I of the valve is greater than the predetermined degree of opening a and so that the pressure that is supplied to the back pressure valve 21 increases when the degree of opening I of the valve is less than the predetermined degree of opening a.

It can be designed further differently. In other words, an upper limit value b of the degree of opening and a lower limit value c of the degree of opening are first set as the above-described predetermined degree of opening a. The control signals are outputted to the air cylinder controller 24 of the air cylinder 22 so that the pressure that is supplied to the back pressure valve 21 is lowered when the degree of opening of the back pressure valve 21 increases to a value that exceeds the upper limit value b and so that the pressure that is supplied to the back pressure valve 21 is increased when the degree of opening of the back pressure valve 21 drops to a value that is lower than the lower limit value c.

Furthermore, the control section 40 in FIG. 1 can perform the dehydration process by way of recording a program, which executes the functions of the air cylinder controller 24, on a computer-readable recording medium, having a computer system read the program thus recorded on the recording medium, and then causing the computer system to execute this program. The term “computer system” used here includes OS (operation systems) and hardware such as peripheral devices, etc.

The term “computer-readable recording medium” refers to a portable medium such as a floppy disk, optical-magnetic disk, ROM, CD-ROM, etc. and a memory device such as a hard disk, etc. that is installed in a computer system. In addition, the term “computer-readable recording medium” includes media that holds programs dynamically for a short period of time, as in communications lines used in cases where programs are transmitted via a network such as the Internet, etc. or via communications circuits such as telephone circuits, etc., and media that hold programs for a fixed period of time, as in volatile memories inside the computer systems that acts as servers and clients in such cases. Furthermore, the above-described program can be a program that executes some of the above-described functions or a program that makes it possible to execute the above-described functions in combination with programs already recorded in the computer system.

The embodiments of the present invention are described in detail above with reference to the accompanying drawings; however, the concrete construction of the present invention is not limited to such embodiments. Designs, etc. within the limit that involves no departure from the spirit of the present invention are also included in the present invention.

According to the present invention, as described above, a back pressure valve that restricts the discharge of the filtered (treated) substance is installed in the discharge port located at another end of the filter body. The degree of opening between the discharge port and the back pressure valve is detected, and the back pressure valve is controlled so that a pressure that corresponds to the detected degree of opening is obtained. Accordingly, an effect that makes it possible to maintain the water content of the substance treated and discharged from the discharge port at a constant value is obtained. Furthermore, since each substance treated has substantially the same water content as other treated substances, the properties of the substance treated are constant, and after-stage treatments are thus advantageously facilitated.

Furthermore, according to the present invention, a pressure detection means that detects the pressure supplied to the back pressure valve by the pressurizing means is provided, and the pressure of the back pressure valve is controlled so that the product of the detection result of the opening detection means and the detection result of the pressure detection means is maintained at a specified value. Accordingly, the water content of the substance treated is maintained at a constant value with a greater precision, and such an effect that the discharge function is maintained in an appropriate manner is obtained.

1. A screw pressing type filtering apparatus comprising a substantially cylindrical filter body and a screw rotatably provided in said filter body so that a substance supplied from one end of said screw into a space between said screw and said filter body is filtered by said filter body while being conveyed to another end of said screw by a rotation of said screw, said filtering apparatus further comprising:
a back pressure valve installed in a discharge port that is at another end of said filter body so as to restrict a discharge of said substance which has been filtered;
a pressurizing means which supplies a pressure to said back pressure valve so as to restrict said discharge of said substance filtered;
an opening detection means which detects a degree of opening between said discharge port and said back pressure valve; and
a control means which controls said pressurizing means based upon detection results of said opening detection means so that a pressure that corresponds to said degree of opening is supplied to said back pressure valve.

2. The screw pressing type filtering apparatus according to claim 1, wherein said control means controls said pressurizing means based upon said detection results of said opening detection means so that a pressure that is supplied to said back pressure valve decreases when said degree of opening of said back pressure valve exceeds a predetermined degree of opening and so that said pressure that is supplied to said back pressure valve increases when said degree of opening of said back pressure valve is less than said predetermined degree of opening.

3. The screw pressing type filtering apparatus according to claim 1, wherein
said pressurizing means has a pressure detection means that detects a pressure supplied to said back pressure valve; and
said control means controls a pressure of said back pressure valve so that a product of detection results of said opening detection means and detection results of said pressure detection means becomes a specified value.

4. The screw pressing type filtering apparatus according to claim 2, wherein
said pressurizing means has a pressure detection means that detects a pressure supplied to said back pressure valve; and
said control means controls a pressure of said back pressure valve so that a product of detection results of said opening detection means and detection results of said pressure detection means is a specified value.

5. The screw pressing type filtering apparatus according to claim 1, wherein said pressurizing means is an air cylinder.

6. The screw pressing type filtering apparatus according to claim 2, wherein said pressurizing means is an air cylinder.

7. The screw pressing type filtering apparatus according to claim 3, wherein said pressurizing means is an air cylinder.

8. The screw pressing type filtering apparatus according to claim 4, wherein said pressurizing means is an air cylinder.

9. A filtration method for a screw pressing type filtering apparatus that comprises a substantially cylindrical filter body and a screw rotatably provided in said filter body so that a substance supplied from one end of said screw into a space between said screw and said filter body is filtered by said filter body while being conveyed to another end of said screw by a rotation of said screw, said method comprising the steps of:
restricting a discharge of a filtered substance by a back pressure valve installed in a discharge port that is at another end of said filter body;
detecting a degree of opening between said discharge port and said back pressure valve; and
supplying a pressure that corresponds to said degree of opening to said back pressure valve based upon detection results of said degree of opening.

10. A recording medium which is recorded with a control program and is used in a screw pressing type filtering apparatus that comprises a substantially cylindrical filter body and a screw rotatably provided in said filter body so that a substance supplied from one end of said screw into a space between said screw and said filter body is filtered by said filter body while being conveyed to another end of said screw by a rotation of said screw, said recording medium causing a computer to execute:
a step of restricting a discharge of a filtered substance by a back pressure valve installed in a discharge port that is at another end of said filter body;
a step of detecting a degree of opening between said discharge port and said back pressure valve; and
a step of supplying a pressure that corresponds to said degree of opening is to said back pressure valve based upon detection results of said degree of opening.
